(19) United States
(12) Patent Application Publication
(10) Pub. No.: US 2018/0093414 A1
(43) Pub. Date: Apr. 5, 2018

(54) METHOD FOR MAKING VEHICULAR BRAKE COMPONENTS BY 3D PRINTING

(71) Applicant: Gerald Martino, Mt. Pleasant, PA (US)

(72) Inventor: Gerald Martino, Mt. Pleasant, PA (US)

(21) Appl. No.: 15/724,013

(22) Filed: Oct. 3, 2017

Related U.S. Application Data
(60) Provisional application No. 62/403,384, filed on Oct. 3, 2016.

(51) Int. Cl. B29C 64/153; B29C 64/165

(52) U.S. Cl. CPC B29C 64/153; F16D 65/12; B29C 64/165

(57) ABSTRACT

A method for making a vehicular brake component comprises: (a) providing a three-dimensional printer; (b) providing the printer with a schematic for making a preform brake rotor or hub; (c) supplying a metal powder to the printer for making the preform brake rotor or hub; (d) forming the preform brake rotor or hub, per the schematic provided and the metal powder supplied to the printer; (e) sintering the preform brake rotor or hub; and (f) applying a wear coating to the sintered preform brake rotor or hub to make the brake component therefrom. Preferably, such brake components, for automotive racing parts, are made from titanium alloy powders.

### CROSS-REFERENCE TO RELATED APPLICATION

This is a perfection of U.S. Provisional Application Ser. No. 62/403,384, filed on Oct. 3, 2016, the disclosure of which is fully incorporated by reference herein.

### FIELD OF THE INVENTION

This invention relates to manufacturing vehicular parts by three-dimensional printing. More particularly, it relates to racing car and/or motorcycle brake rotors and the method of 3D printing same from titanium and/or other metal alloys.

### BACKGROUND OF THE INVENTION

Traditionally automotive brake rotors have been made using cast iron. They are well known to provide good wear resistance and high temperature properties. However, cast iron is dense relative to other materials so that a cast iron brake rotor is heavy. A heavy brake rotor is undesirable for at least three reasons: (1) a heavy brake rotor contributes to the overall weight of a motor vehicle thus reducing its fuel efficiency and increasing its emissions. (2) a brake rotor is part of the unsprung vehicle weight, meaning the weight below the springs. Unsprung weight adds to the noise, vibration, and harshness (sometimes referred to as “NVH”) associated with vehicle operation. When unsprung weight is reduced, NVH is usually improved. (3) a brake rotor is a vehicle part that requires rotation during use. Accordingly a heavier brake rotor requires additional energy to increase and decrease rotational speed. Reducing weight of a vehicle rotor also lowers vibration during rotation. Carbon-carbon composites, ceramics, and “cermets” have been considered for use in brake rotors but they are expensive and have not achieved widespread adoption as vehicle rotors.

Titanium has been considered as brake rotor material per Murphy U.S. Pat. No. 5,521,015 and Martino U.S. Pat. No. 5,901,818, both incorporated herein by reference. Titanium has excellent strength to weight properties, and it retains strength at high temperatures. However, high costs have heretofore prevented the widespread adoption of titanium and its alloys for vehicle brake rotors. Accordingly there still remains a need for a lower cost process to make titanium brake rotors, especially those with a complicated shape/profile.

Other brake rotors are shown in U.S. Pat. No. 4,278,153, which discloses a brake disc frictional module composed of sintered metallic material reinforced throughout its entire volume by a grid system of pure metal or metallic alloy. That friction module may be manufactured by sintering the metallic material with the grid reinforcement in either a mold or within the brake disc cup. The internal reinforcement of the frictional module prevents spalling weight loss, friction coefficient decay, or other physical defect as caused by frictional strain during use. The reinforcement material reduces the overall temperature of the disc during use, and aids frictional coefficient of the disc because of the metallic compatibility of the metallic material and grid system.

U.S. Pat. No. 5,620,791 discloses metal and ceramic matrix composite brake rotors comprising an interconnected matrix embedding at least one filler material. In the case of metal matrix composite materials, at least one filler material comprises at least about 26% by volume of the brake rotor for most applications, and at least about 20% by volume for applications involving passenger cars and trucks.

U.S. Pat. No. 4,381,942 discloses a process for the production of titanium-based alloy members by powder metallurgy. It consists of: (a) preparing a titanium or titanium alloy powder having a certain grain size distribution, (b) depositing on said powder a coating of a material such that on contact with the titanium or titanium alloy it forms a liquid phase at a temperature below the allotropic transformation temperature T of the titanium or titanium alloy constituting the said powder, (c) introducing the thus coated powder into a mold, and (d) hot compressing this powder in the mold at a certain pressure and temperature until complete densification of the powder is obtained.

U.S. Pat. No. 4,719,074 discloses a metal-ceramic composite article produced by fitting a projection formed on a ceramic member into a hole formed in a metallic member having a hardened region and an unhardened region on its surface such that the ceramic member is monolithically bonded to the metallic member and the deformed region of the metallic member resulting from the fitting is located within its unhardened range, has a high bonding force between the ceramic member and the metallic member and is adapted to be used in engine parts, such as turbocharger rotor, gas turbine rotor and the like, and other structural parts exposed to high temperature or to repeating loads, by utilizing the heat resistance, wear resistance and high strength of the ceramic.

U.S. Pat. No. 5,053,192 discloses deforming combustion products by extrusion at an certain extrusion temperature in a container made up of vertically extending segments defining spaces with one another and having a die and a heat insulated sizing member, the temperature conditions of extrusion being controlled by means of a unit having a temperature pick-up and a member receiving information from the pick-up and sending a command for moving the punch.

U.S. Pat. No. 5,139,720 discloses manufacturing a sintered ceramic material using the heat generated in a thermit reaction as a heating source, a pre-heating is applied preceding to the sintering step or a mixture comprising: (A) at least one ceramic powder, (B) at least one non-metallic powder selected from the group consisting of carbon, boron and silicon, and (C) a metal powder and/or a non-metallic powder other than the above-mentioned (B) is used. Homogeneous and dense sintered ceramic material or sintered composite ceramic material can be obtained by this method, and the fine texture thereof, and the phase constitution, the phase distribution and the like of the composite ceramic phase can be controlled sufficiently.

U.S. Pat. No. 5,701,943 discloses a metal matrix composite made by blending non-metal reinforcement powder with powder of metal or metal alloy matrix material, heating to a temperature high enough to cause melting of the matrix metal/alloy and subjecting the mixture to high pressure in a die press before solidification occurs.

As for currently known three-dimensional printing practices, consider the following internet links:

http://www.exone.com/

http://www.eos.info/systems_solutions/metal

http://www.3dsystems.com/3d-printers/production/overview

https://www.stratasysdirect.com/technologies/direct-metal-laser-sintering/

http://www.purisllc.com/

A principal advantage of the present invention is that it enables greater, more efficient manufacturing of vehicular brake rotors especially those used for automotive (and/or motorcycle) racing applications. Other advantages of the invention will become readily apparent to persons skilled in the art from the following specification and claims.

### SUMMARY OF THE INVENTION

Three versions of automotive brake rotor may be made by the methods described herein:

1. A 3D printed rotor, made from straight titanium powder alloys

2. A printed rotor with one or more printed coatings applied thereon/thereover; and

3. A printed rotor with a thermally-sprayed coating applied thereto.

### Process:

A direct metal laser sintering;

A binder-based 3D printing; and/or

A laser metal deposition (or LMD).

### Materials:

All titanium, stainless steel, and steel alloys

For a representative Ti brake component, suitable alloys include Ti-6Al-4V, Ti-6Al-6V-2Sn, Ti-6Al-2Sn-4Zr-2Mo, Ti-10V-2Fe-3Al, and Ti-5Al-2.5Sn.

After manufacture of the primary brake part, such as a rotor, it may be further coated with a mixture containing about 30-95 parts by weight titanium or titanium alloy and about 5-70 parts by weight of a nonmetallic material. The latter may include particles, fibers, whiskers, flakes, or mixtures thereof. Suitable nonmetallic materials are ceramics including silicon carbide, boron carbide, tungsten carbide, chromium carbide, alumina, zirconium oxide, silicon nitride, boron nitride, and titanium diboride, solely or in various combinations with each other. Optionally the mixture may contain up to about 10 parts by weight of an organic binder, as explained below in more detail.

With further advances in 3D printing practices, this invention anticipates making (i.e. printing) a main brake component from a first material, then having a 3D coated layer integrally formed thereon (rather than applied in a subsequent processing step).

This invention provides an improved method for making a vehicle brake rotor by employing 3D printing practices. A wear surface coating may be applied by plasma spraying to that 3D printed part. Or, the coating may be integrally printed as the body of the main component gets manufactured. This coating may include a bond coat containing nickel, an intermediate coat comprising zirconium oxide, chromium carbide, and nickel, and a top coat comprising zirconium oxide and chromium carbide. The topcoat can comprise about 65 to 75 parts by weight zirconia and about 25 to 35 parts by weight chromium carbide, and the bond coat further can contain aluminum. The top-coat and the intermediate coat can contain a lesser amount of nickel and aluminum than the bond coat.

Specifically, to first and second side of each 3D printed brake rotor, there may be applied a coating comprised of a bond coat of about 4.5 wt. % aluminum and about 95.5 wt. % nickel; an intermediate coat of about 70 parts by weight zirconia, 30 parts by weight of a composition as used for the bond coat, and 10 parts by weight chromium carbide; and a top coat of about 70 parts by weight zirconium oxide and about 30 parts by weight chromium carbide.

The metallic powder used for such 3D part printings may be selected from the group consisting of titanium, steel, stainless steel, cast iron, and alloys thereof.

An improved titanium brake rotor is provided comprised of a central layer of a metal or metal alloy sandwiched between two outside layers comprised of a mixture of metal or metal alloy and a nonmetallic material, which outside layer provides brake wear layers on the rotor. These rotors may be formed as described herein.

In another aspect of the invention, a method for 3D printing a vehicular braking device comprises a brake rotor and hub. The rotor and hub are comprised of titanium or titanium alloy.

The improved rotor is comprised of a central layer of titanium metal or metal alloy sandwiched between two outside layers that are comprised of a mixture of titanium metal or metal alloy and a non-metallic material providing wear layers on the rotor. A hub may be diffusion bonded to the rotor to provide the braking device.

### BRIEF DESCRIPTION OF THE DRAWINGS

Further features, objectives and advantages of this invention will be made clearer with the following detailed description of preferred embodiments made with reference to the accompanying drawings in which:

FIG. 1 is a top plan view of a representative racing brake rotor according to this invention;

FIG. 2 is a sectional view taken along lines II-II of FIG. 1;

FIG. 3 is a side plan view of the rotor from FIG. 1; and

FIG. 4 is a sectional view taken along lines IV-IV of FIG. 3.

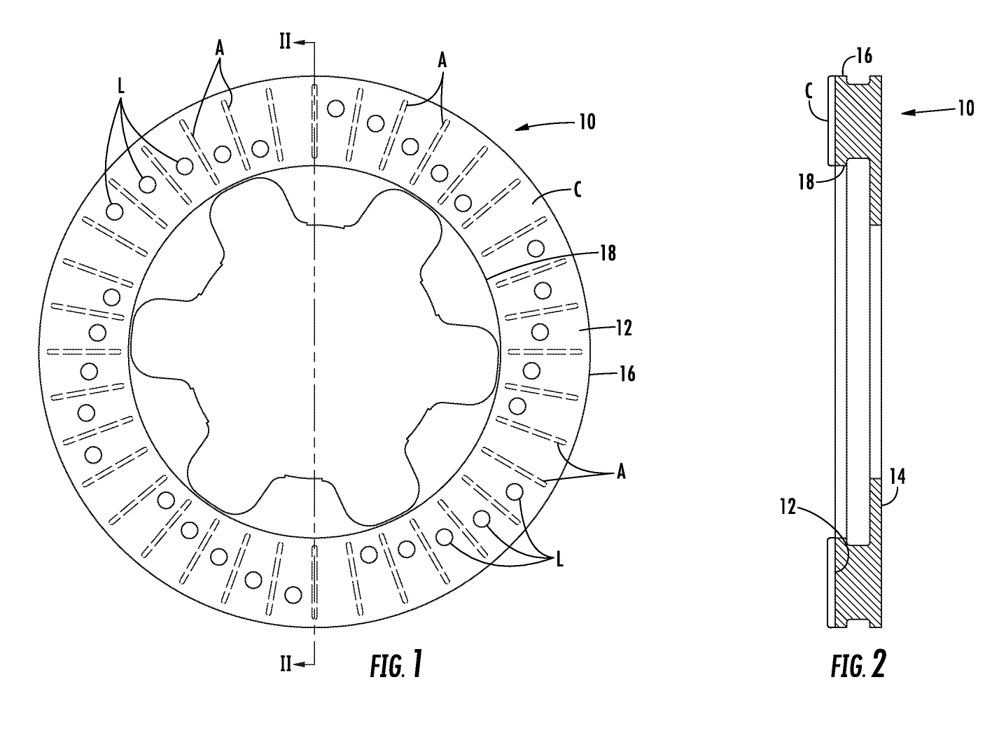

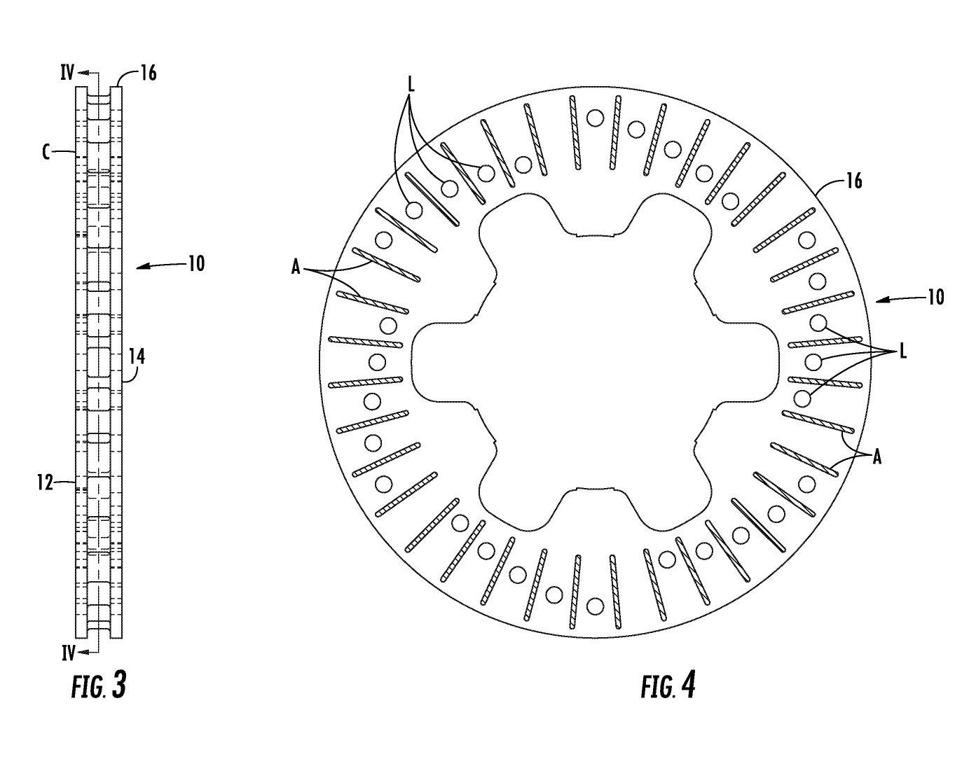

### DESCRIPTION OF PREFERRED EMBODIMENTS

Referring now to the accompanying FIGS., a representative racing brake rotor 10 includes two opposite braking surfaces, an outer surface 12 and an inner surface 14 that are oriented parallel to one another. Rotor 10 also has an outer periphery 16 and an inner periphery 18. This representative rotor 10 will have a series of holes or apertures A distributed on its braking surfaces and passing through the rotor, from one braking surface on one side to the braking surface on the other side of this rotor. They allow for air passage through the rotor proper and assist with cooling of the unit. A plurality of lug/stud holes L may be arranged uniformly about the inner peripheral surface of the rotor and extend radially inwardly. A bond coating C is applied thereto, either after 3D printing or concurrent therewith.

Each 3D printed rotor hereby would include a substrate having a braking surface on each of its two broad sides. Each braking surface is composed of two layers, referred to as “coats”. Thus, each braking surface is composed of a bond coat and a topcoat. Generally, the bond coat may include a thin layer comprised of nickel and the topcoat a ceramic composition of zirconium oxide and chromium carbide. Both bond coat and topcoat may be applied to the braking surfaces by plasma spraying techniques. Alternately, they may be integrally formed WITH the braking surface as part of a multiple component, multiple material 3D printing process. Following application of these bond and topcoats, the braking surface should be ground smooth.

As a general rule, increasing the chromium carbide relative to the zirconium oxide increases the wear resistance of the braking surface, while increasing the zirconium oxide relative to the chromium carbide increases the coefficient of friction of the braking surface.

Coatings composed of more than two layers may, of course, be used, and may even be preferred, for instance for the purpose of making transitions between different coefficients of thermal expansion less abrupt, or for the purpose of introducing various kinds of materials offering special advantages.

The rotors of this invention may, or may not, have holes in their braking surfaces. Wear layers may be formed on such rotors after initial 3D printing or as part of the overall component printing process.

Suitable materials for the main braking substrate include cast iron, steel, titanium and its alloys described above, and certain titanium composites.

The brake rotor described above may also be used for some applications without any coating. For most uses however, a coating is applied to the braking surfaces. In preparation for receipt of the coating, the braking surface may be grit-blasted or sand-blasted in a cabinet for capturing used media.

In one case, a braking surface may be bond coated, after 3D printing, with nickel aluminide to a thickness of about 0.005 inch. The thickness of this bond coating may range between about 0.001 inch to about 0.03 inch. That component could have its alloy applied by plasma spraying. Next, an intermediate coat would be applied by plasma spraying. That intermediate coat could consist of about 70 parts by weight yttria stabilized zirconium oxide, 30 parts by weight of the composition used for the bond coat, and about 10 parts by weight chromium carbide.

Finally a topcoat could be applied thereover by plasma spraying. The topcoat comprises about 70 parts by weight yttria stabilized zirconium oxide and about 30 parts by weight chromium carbide.

Having described the presently preferred embodiments, it is to be understood that the invention may be otherwise embodied within the scope of the appended claims.

What is claimed is:

1. A method for making a vehicular brake component comprises: (a) providing a three-dimensional printer; (b) providing the printer with a schematic for making a preform brake rotor or hub; (c) supplying a metal powder to the printer for making the preform brake rotor or hub; (d) forming the preform brake rotor or hub, per the schematic provided and the metal powder supplied to the printer; (e) sintering the preform brake rotor or hub; and (f) applying a wear coating to the sintered preform brake rotor or hub to make the brake component therefrom.

2. The method of claim 1 wherein said brake rotor or hub has a wear layer containing 5-60 wt. % of a nonmetallic material.

3. The method of claim 2 wherein said nonmetallic material is at least one of the group consisting of silicon carbide, boron carbide, tungsten carbide, chromium carbide, alumina, zirconium oxide, silicon nitride, boron nitride, and titanium diboride.

4. The method of claim 2 wherein said nonmetallic material is silicon carbide.

5. The method of claim 1 wherein said brake component is a double vane rotor for an automotive racing vehicle.

6. The method of claim 1 wherein step (d) includes forming said preform by direct metal laser sintering.

7. The method of claim 1 wherein step (d) includes forming said preform by binder-based 3D printing.

8. The method of claim 1 wherein step (d) includes forming said preform by laser metal deposition.

9. The method of claim 1 wherein the metal powder is selected from the group consisting of titanium alloy, a stainless steel alloy and a steel alloy.

10. The method of claim 9 wherein the titanium alloy is selected from the group consisting of: Ti-6Al-4V, Ti-6Al-6V-2Sn, Ti-6Al-2Sn-4Zr-2Mo, Ti-10V-2Fe-3Al, and Ti-5Al-2.5Sn.

11. A method for making an automotive brake rotor comprises: (a) providing a three-dimensional printer; (b) providing the printer with a schematic for making a preform of the brake rotor; (c) supplying the printer with a feedstock of titanium alloy powder; (d) making the brake rotor preform from the titanium powder supplied to the printer; (e) sintering the brake rotor preform; and (f) applying a bond coat to the sintered brake rotor preform.

12. The method of claim 11 wherein the titanium alloy is selected from the group consisting of: Ti-6Al-4V, Ti-6Al-6V-2Sn, Ti-6Al-2Sn-4Zr-2Mo, Ti-10V-2Fe-3Al, and Ti-5Al-2.5Sn.

13. The method of claim 11 wherein a nonmetallic material is 3d printed on an outer wear surface of the brake rotor preform.

14. The method of claim 13 wherein the nonmetallic material is integrally applied to the outer wear surface of the brake rotor preform during printing of the brake rotor preform.

15. The method of claim 13 wherein the nonmetallic material is applied to the outer wear surface of the brake rotor preform after printing of the brake rotor preform.

16. The method of claim 13 wherein the nonmetallic material includes silicon carbide.
